(19) United States
(12) Patent Application Publication
(10) Pub. No.: US 2014/0249997 A1
(43) Pub. Date: Sep. 4, 2014

(54) ELECTRONIC RECEIPT SYSTEM, ELECTRONIC RECEIPT MANAGEMENT SERVER, INFORMATION PROCESSING DEVICE AND PROGRAM

(71) Applicant: Toshiba Tec Kabushiki Kaisha, Tokyo (JP)

(72) Inventors: Akiko SUSAKI, Tokyo (JP); Shinya TAKAKURA, Shizuoka (JP); Hiroaki IMAI, Osaka (JP); Kunihiro YAMADA, Osaka (JP); Masayoshi NAKATANI, Shizuoka (JP); Takamitsu MUKUNASHI, Aichi (JP)

(73) Assignee: Toshiba Tec Kabushiki Kaisha, Tokyo (JP)

(21) Appl. No.: 14/194,561

(22) Filed: Feb. 28, 2014

(30) Foreign Application Priority Data
Mar. 1, 2013 (JP) 2013-172414

(51) Int. Cl. G06Q 20/08

(52) U.S. Cl. CPC G06Q 20/08
USPC 705/39

(57) ABSTRACT

An electronic receipt system includes an electronic receipt generation unit configured to generate electronic receipt information relating to merchandise sales data, and correlate the electronic receipt information with a code of a consumer, an electronic receipt management unit configured to associate the electronic receipt information with a company code, an electronic receipt collective management unit configured to manage the electronic receipt information collectively for a plurality of the companies, a group associating unit configured to define a group by associating codes of different consumers with the group, and an electronic receipt transmission unit configured to transmit the electronic receipt information to information processing devices that are correlated with the codes that are associated with the group. An electronic receipt display unit of an information processing device is configured to display the electronic receipt information transmitted by the electronic receipt transmission unit.

### CROSS-REFERENCE TO RELATED APPLICATION

This application is based upon and claims the benefit of priority from Japanese Patent Application No. 2013-41290, filed Mar. 1, 2013 and Japanese Patent Application No. 2013-172414, filed Aug. 22, 2013; the entire contents of both applications are incorporated herein by reference.

### FIELD

Embodiments described herein relate generally to an electronic receipt system, an electronic receipt management server, an information processing device and a program.

### BACKGROUND

In the related art, an electronic receipt system is known in which a receipt is electronically passed from a store to a consumer when the consumer pays for a product sold by the store.

By providing a receipt in electronic data form, there is benefit to the consumer in that a household account book may be kept automatically in electronic form, and the like. In addition, since it is possible to reduce the consumption of receipt paper by providing electronic receipts, there is also a benefit to stores which provide electronic receipts.

However, the electronic receipt system of the related art is confined to use in managing the information of products that are purchased by an individual, and it is still necessary to create the household account book manually when managing the electronic receipts for a group such as a family or other grouped entity. Therefore, there is room for improvement in the convenience of managing electronic receipts for a group.

### DESCRIPTION OF THE DRAWINGS

FIG. 1 is a configuration diagram illustrating an overall configuration of an electronic receipt system according to an embodiment.

FIG. 2 is a block diagram illustrating the configuration of various components of a portable terminal.

FIG. 3 is a block diagram illustrating the configuration of various components of a POS terminal.

FIG. 4 is a block diagram illustrating the configuration of various components of an electronic receipt server.

FIG. 5 is a block diagram illustrating the configuration of various components of an electronic receipt management server.

FIG. 6 is a functional block diagram of an electronic receipt process performed in the POS terminal.

FIG. 7 is a flow chart illustrating the flow of the electronic receipt process.

FIG. 8 is a flow chart illustrating the flow of an information transmission process in the electronic receipt server.

FIG. 9 is a functional block diagram of an electronic receipt management process and a product information transmission process performed in the electronic receipt management server.

FIG. 10 is a flow chart illustrating the flow of the electronic receipt management process and the product information transmission process.

FIG. 11 is a functional block diagram of an electronic receipt receiving process and an electronic receipt viewing process performed in the portable terminal.

FIG. 12 is a flow chart illustrating the flow of the electronic receipt receiving process and the electronic receipt viewing process.

FIG. 13 is a flow chart illustrating the flow of the electronic receipt receiving process and the electronic receipt viewing process.

FIG. 14 is a configuration diagram illustrating the overall configuration of an electronic receipt system according to an embodiment in a case in which merchandise sales data is shared.

FIGS. 15A to 15E are transition diagrams illustrating a transition example of a screen in a setting registration of a group that shares the merchandise sales data.

FIG. 16 is a front view illustrating a display example of the portable terminal.

FIG. 17 is a front view illustrating a display example of the portable terminal.

FIG. 18 is a front view illustrating a display example in relation to a display unit of the portable terminal.

FIGS. 19A to 19D are transition diagrams illustrating a transition example of a screen in a setting registration in which sharing of the merchandise sales data is set.

FIGS. 20A and 20B are transition diagrams illustrating a transition example of a screen during searching for a product or the like to be shared from a list of receipts.

FIGS. 21A to 21C are transition diagrams illustrating a transition example of a screen during searching for a product or the like to be shared from a list of stores.

FIGS. 22A to 22C are transition diagrams illustrating a transition example of a screen during searching for a product or the like to be shared with a product name.

FIGS. 23A and 23B are transition diagrams illustrating a transition example of a screen during searching for an electronic receipt or the like to be concealed from a list of receipts.

FIGS. 24A and 24B are transition diagrams illustrating a transition example of a screen during searching for a company or the like to be concealed from a list of stores.

FIGS. 25A and 25B are transition diagrams illustrating a transition example of a screen during searching for a product or the like to be concealed with a product name.

### DETAILED DESCRIPTION

In general, according to one embodiment, there is provided an electronic receipt system, an electronic receipt management server and a program, each of which is capable of promoting the introduction of electronic receipts.

In general, according to one embodiment, there is provided an electronic receipt system which includes an electronic receipt generation unit, an electronic receipt management unit, an electronic receipt collective management unit, a group associating unit, an electronic receipt transmission unit, and an electronic receipt display unit. The electronic receipt generation unit generates electronic receipt information relating to merchandise sales data, and correlates the electronic receipt information with a code of a consumer. An electronic receipt management unit associates the electronic receipt information generated by the electronic receipt generation unit with a company code, and stores the electronic receipt information in a storage unit. An electronic receipt collective management unit manages the electronic receipt information collectively for a plurality of the companies, each associated with a different company code. The group associating unit defines a group by associating membership codes of different consumers with the group. An electronic receipt transmission unit transmits the electronic receipt information to information processing devices that are correlated with the membership codes that are associated with the group. The electronic receipt display unit of an information processing device displays the electronic receipt information transmitted by the electronic receipt transmission unit.

Description will be given below of an embodiment on the basis of the drawings.

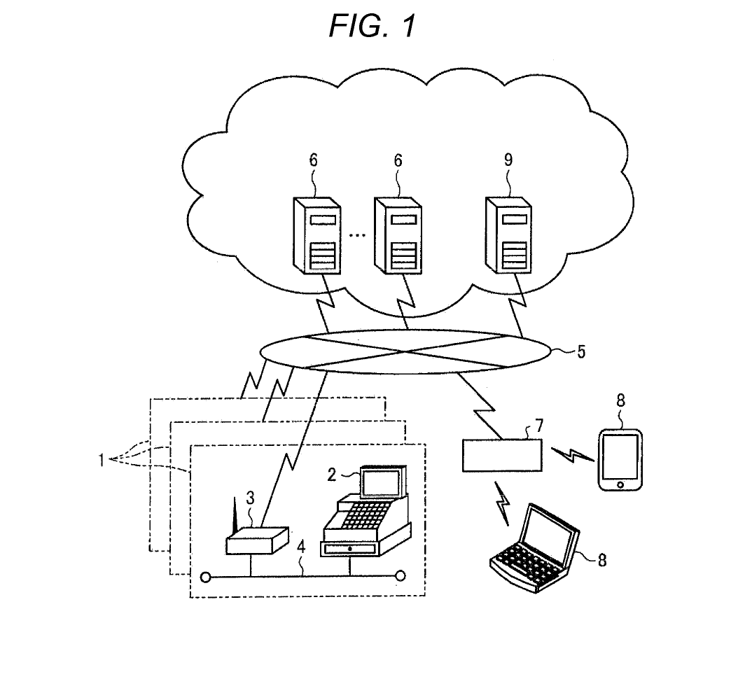

FIG. 1 is a configuration diagram showing the overall configuration of an electronic receipt system according to an embodiment. As shown in FIG. 1, a point of sales (POS) terminal 2 (only one is shown in FIG. 1, however, there may also be a plurality), which is a merchandise sales data processing device which executes the merchandise sales data processing, and a router 3 are installed in a store 1. The POS terminal 2 and the router 3 are connected using an in-store Local Area Network 4 (LAN). The router 3 is a device for connecting the in-store LAN 4 to a network 5, which is the Internet or a virtual private network (VPN). Furthermore, while not particularly shown in the drawings, the store 1 may also be provided with a store server, which controls the POS terminal 2.

An electronic receipt server 6 is connected to the network 5. A plurality of electronic receipt servers 6 are provided, one for each company, which is the seller of products or services, that operates a store or a chain store (hereinafter referred to as a store) such as a convenience store, a supermarket, a grocery store, a drugstore, an apparel store, a home electric appliance shop, a department store, a household goods store or a restaurant. The electronic receipt server 6 functions as a company receipt management server, which stores and manages electronic receipt information for each company based on a corresponding company code, which indicates the company that owns or manages a store. Furthermore, the electronic receipt server 6 may also be configured to utilize a head office server of a POS system, which includes functions such as sales management, sales analysis and stock management of each company which owns or manages a store.

In addition, a portable terminal 8 is connected to the network 5 via a base station 7, which performs wireless communication according to a standard such as wireless fidelity (Wi-Fi). The portable terminal 8 is an information processing device, which implements a web browser thereon, such as a smart phone, a mobile telephone, a personal digital assistant (PDA) or a tablet computer, for example. Furthermore, instead of the portable terminal 8, an information processing device such as a personal computer such as a laptop PC may also be used.

Furthermore, an electronic receipt management server 9, manages the electronic receipt information of various companies that own or manage stores, in a collective manner, is also connected to the network 5. A consumer, who is registered as a member in the electronic receipt system, may obtain electronic receipt information from the electronic receipt management server 9 using the portable terminal 8, via the network 5. The electronic receipt management server 9, for example, is managed by a third party organization other than the company which manages the electronic receipt information using the electronic receipt server 6. Furthermore, the electronic receipt server 6 may also be managed by a third party organization or the like. In addition, the functions of the electronic receipt server 6 may also be maintained in the electronic receipt management server 9 so that management is performed on one server. In addition, a function in which the electronic receipt information is managed collectively using company codes may also be provided as a service (an application) in the form of software as a service (SaaS), which is a type of cloud computing, for example.

In the electronic receipt system with the configuration described above, the electronic receipt information that shows information concerning payment, which is generated by performing the merchandise sales data processing using the POS terminal 2 of the store 1, is transmitted to the electronic receipt management server 9 via the electronic receipt server 6 via the network 5. The electronic receipt information is transmitted from the electronic receipt management server 9 to the portable terminal 8 of a member. The member may cause the display unit of the portable terminal 8 to display the electronic receipt information, and may confirm the content of the electronic receipt by viewing thereof on the display unit. In addition, the electronic receipt management server 9 publishes the electronic receipt information on the web. The portable terminal 8, which implements a web browser by specifying a uniform resource locator (URL), may download the electronic receipt information, which is published on the web, and a user may thus view the electronic receipt information using the web browser. Furthermore, a configuration may also be adopted in which application software for viewing the electronic receipt information is installed on the portable terminal 8 and the electronic receipt information is viewed using the application software.

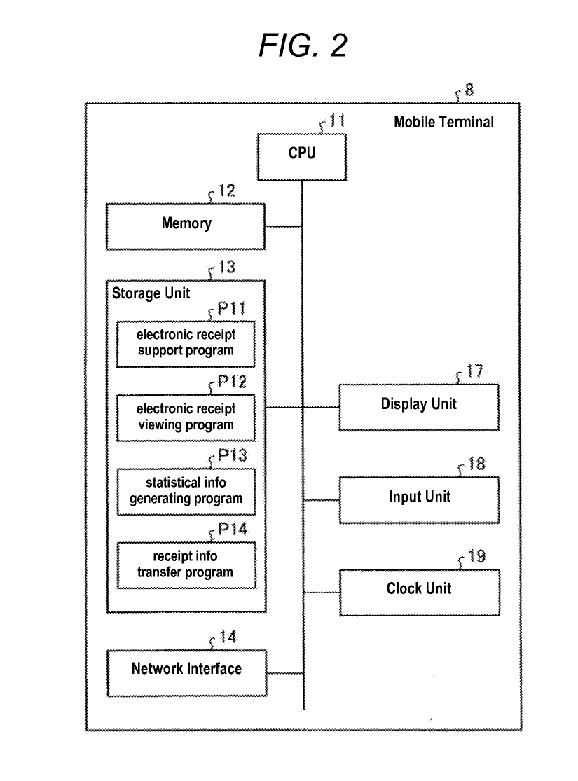

The portable terminal 8 stores the membership code and password, which the consumer acquires in the manner described above, in a storage unit 13 (refer to FIG. 2). As the output method of the membership code, which is stored in this manner, display thereof as a bar-code, display as a two-dimensional code, transmission by information communication using near field communication (NFC), which is near field wireless communication, and the like may be used.

Furthermore, association between the membership code, which is acquired in order for the consumer to receive the electronic receipt service, and an existing company membership card of a point service (loyalty program) or the like, which is operated by a company of a chain store or the like, may be realized using the POS terminal 2 of each retail store or the portable terminal 8 of each individual person.

Description will be given of the configuration of each component that comprises the electronic receipt system of the embodiment.

First, description will be given of the configuration of various components of the portable terminal 8, which is the information processing device, using the block diagram of FIG. 2. As shown in FIG. 2, the portable terminal 8 is configured by a central processing unit (CPU) 11, memory 12, the storage unit 13, a network interface 14, a display unit 17, an input unit 18, a clock unit 19 and the like. The CPU 11 functioning as the control unit, the memory 12 is for temporarily storing data, data may be read from and written to the storage unit 13 using commands from the CPU 11 and programs, data and the like are stored thereon, the network interface 14 is connected to various public networks including the network 5, the display unit 17 is capable of displaying various information, the input unit 18 is for operating the portable terminal 8, and the clock unit 19 tracks time. The input unit 18 is a touch panel laminated onto the display unit 17, or a key provided on a housing.

In addition to a web browser for viewing various information (content) published on the web, an electronic receipt handling program P11 and an electronic receipt viewing program P12 are pre-installed on the storage unit 13. The electronic receipt handling program P11 is for receiving the electronic receipt information, which is generated after payment according to the merchandise sales data processing, from the electronic receipt management server 9. The electronic receipt viewing program P12 is for viewing the received electronic receipt information.

In addition, a statistical information generation program P13 is pre-installed on the storage unit 13. The statistical information generation program P13 is for statistically collecting the electronic receipt information, which is received from the electronic receipt server 6 of each company described later herein, and for generating statistical information on the basis of the company code and the business type and business category code of purchases.

Furthermore, a receipt information delegation program P14 for dividing up sales transactions of the electronic receipt information and delegating portions of the divided electronic receipt information to a portable terminal of another member is pre-installed on the storage unit 13.

Furthermore, the electronic receipt handling program P11, the electronic receipt viewing program P12, the statistical information generation program P13 and the receipt information delegation program P14, which are executed by the portable terminal 8, are provided to the portable terminal as a file of an installable format or an executable format by being recorded to a recording medium, which is readable to a computer, such as a CD-ROM, a flexible disk (FD), a CD-R, or a digital versatile disk (DVD).

In addition, a configuration may also be adopted in which the electronic receipt handling program P11, the electronic receipt viewing program P12, the statistical information generation program P13 and the receipt information delegation program P14, which are executed by the portable terminal 8, are provided thereto by being stored on a computer that is connected to a network such as the Internet and downloaded via the network. In addition, a configuration may also be adopted in which the electronic receipt handling program P11, the electronic receipt viewing program P12, the statistical information generation program P13 and the receipt information delegation program P14, which are executed by the portable terminal 8, are provided or distributed thereto via a network such as the Internet.

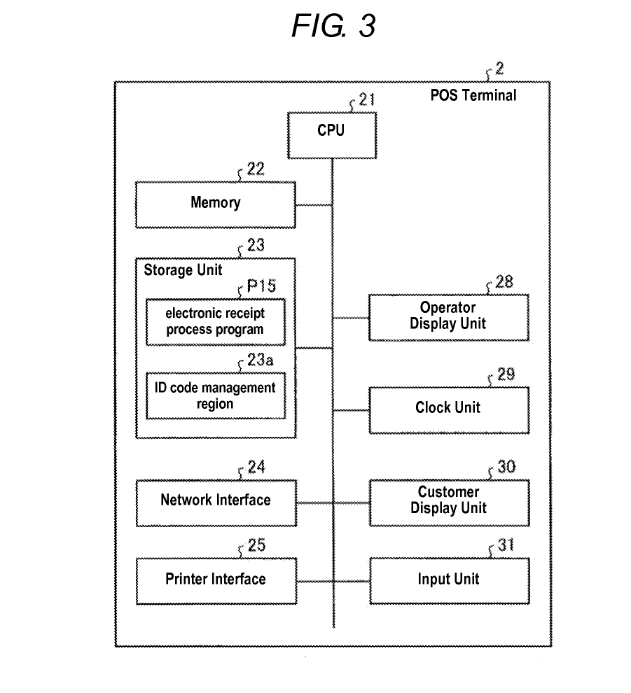

Next, description will be given of the configuration of various components of the POS terminal 2, which is a merchandise sales data processing device, using the block diagram of FIG. 3. As shown in FIG. 3, the POS terminal 2 is configured by a central processing unit (CPU) 21, memory 22, a storage unit 23, a network interface 24, a printer interface 25, an operator display unit 28, a clock unit 29, a customer display unit 30, an input unit 31 and the like. The CPU 21 functioning as the control unit, the memory 22 is for temporarily storing data, data may be read from and written to the storage unit 23 using commands from the CPU 21 and programs, data and the like are stored thereon, the network interface 24 is connected to the in-store LAN 4, the printer interface 25 is connected to a printer, the operator display unit 28 is for displaying various information to the operator, the clock unit 29 measures time, the customer display unit 30 is for displaying various information to the customer, and the input unit 31 is for operating the POS terminal 2.

An identification code management region 23a is secured in the storage unit 23 as a region for pre-storing, in addition to a POS number of the POS terminal 2, the company code (an identification code of the company which owns or manages the store), the business type and business category code, the store code, which indicates the store 1 in which the POS terminal 2 is installed, and the like. Here, the business type and business category code is a code (a classification code) which distinguishes the business type and business category of the store as, for example, a convenience store, a supermarket, a department store, a pharmacy, a restaurant, an restaurant or the like. Furthermore, the business type and business category may be changed arbitrarily according to the preference of the user. Furthermore, the company code (the identification code of the company that operates the store) and the business type and business category code may also be registered in the electronic receipt server 6.

In addition, an electronic receipt processing program P15 is also installed on the storage unit 23 in advance in addition to software for executing various POS work including the merchandise sales data processing. The electronic receipt processing program P15 is for processing electronic receipt information, which is electronically processed when performing the merchandise sales data processing instead of a receipt or an addressed receipt, which is issued by printing.

Furthermore, the electronic receipt processing program P15, which is executed by the POS terminal 2, is provided to the POS terminal 2 as a file of an installable format or an executable format by being recorded to a recording medium, which is readable to a computer, such as a CD-ROM, a flexible disk (FD), a CD-R, or a digital versatile disk (DVD).

In addition, a configuration may also be adopted in which the electronic receipt processing program P15, which is executed by the POS terminal 2, is provided thereto by being stored on a computer that is connected to a network such as the Internet and downloaded via the network. In addition, a configuration may also be adopted in which the electronic receipt processing program P15, which is executed by the POS terminal 2, is provided or distributed thereto via a network such as the Internet.

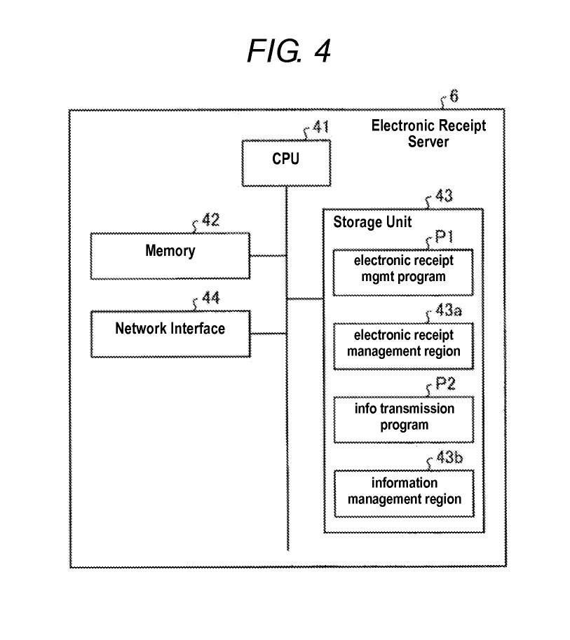

Next, description will be given of the configuration of various components of the electronic receipt server 6, which functions as a company receipt management server, using the block diagram of FIG. 4. The electronic receipt server 6 is configured by a central processing unit (CPU) 41, memory 42, a storage unit 43, a network interface 44 and the like. The CPU 41 functioning as the control unit, the memory 42 is for temporarily storing data, data may be read from and written to the storage unit 43 using commands from the CPU 41 and programs, data and the like are stored thereon and the network interface 44 is connected to the network 5.

In addition, an electronic receipt management region 43a is secured in the storage unit 43 as a region for storing electronic receipt information for each company that operates a store. The electronic receipt information contains the company code (the identification code of the company that operates the store), the business type and business category code, the store code, the membership code of the consumer, the POS number of the POS terminal 2, the receipt number, the merchandise sales data and the like.

In addition, an electronic receipt management program P1 for managing the electronic receipt information, which is received from the POS terminal 2 of each of the stores 1, using the electronic receipt management region 43a is installed in advance on the storage unit 43.

In addition, an information transmission program P2 for transmitting the electronic receipt information, which is managed in the electronic receipt management region 43a, to the electronic receipt management server 9 is installed in advance on the storage unit 43.

Furthermore, an information management region 43b, which stores the various types of additional information that is correlated with the desired product, the membership, the company and the store, is provided in the storage unit 43. Here, the term. “additional information” refers to access information such as a URL that links to a home page associated with a campaign of a company, a URL that links to a home page associated with a commercial of a company, a URL that links to a coupon of a company and the like.

Furthermore, the electronic receipt management program P1 and the information transmission program P2, which are executed by the electronic receipt server 6, are provided thereto as a file of an installable format or an executable format by being recorded to a recording medium, which is readable to a computer, such as a CD-ROM, a flexible disk (FD), a CD-R, or a digital versatile disk (DVD).

In addition, a configuration may also be adopted in which the electronic receipt management program P1 and the information transmission program P2, which are executed by the electronic receipt server 6, are provided thereto by being stored on a computer that is connected to a network such as the Internet and downloaded via the network. In addition, a configuration may also be adopted in which the electronic receipt management program P1 and the information transmission program P2, which are executed by the electronic receipt server 6, are provided or distributed thereto via a network such as the Internet.

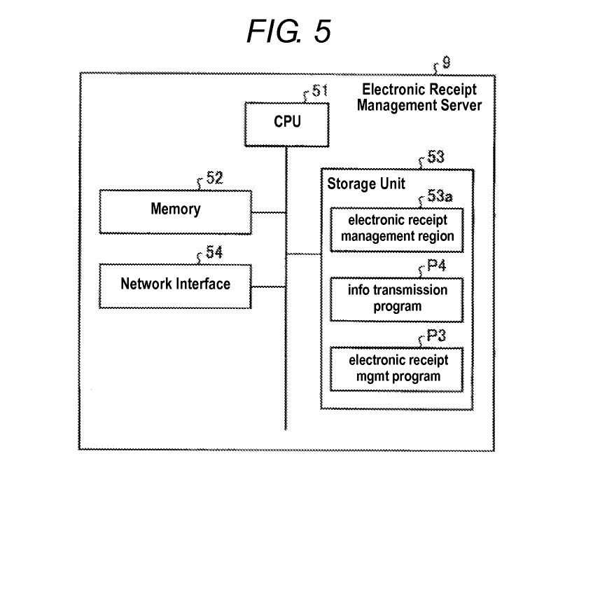

Next, description will be given of the configuration of various components of the electronic receipt management server 9, which functions as a customer receipt management server, using the block diagram of FIG. 5. The electronic receipt management server 9 is configured by a central processing unit (CPU) 51, memory 52, a storage unit 53, a network interface 54 and the like. The CPU 51 functioning as the control unit, the memory 52 is for temporarily storing data, data may be read from and written to the storage unit 53 using commands from the CPU 51 and programs, data and the like are stored thereon and the network interface 54 is connected to the network 5.

An electronic receipt management region 53a is secured in the storage unit 53 as a region for storing electronic receipt information of various companies that operate a store in batches. More specifically, in the electronic receipt management region 53a, the electronic receipt information and the additional information of the various companies that operate a store for each member are managed. The electronic receipt information contains the membership code, the company code (the identification code of the company that operates the store), the store code, the POS number of the POS terminal 2, the receipt number, the merchandise sales data, the additional information and the like.

In addition, an electronic receipt management program P3 for managing the additional information and the electronic receipt information, which are received from the electronic receipt server 6 of each of the companies, using the electronic receipt management region 53a is pre-installed on the storage unit 53.

In addition, an information transmission program P4 for transmitting the electronic receipt information and the additional information of the desired product to the portable terminal 8 is pre-installed on the storage unit 53.

Furthermore, the electronic receipt management program P3 and the information transmission program P4, which are executed by the electronic receipt management server 9, are provided thereto as a file of an installable format or an executable format by being recorded to a recording medium, which is readable to a computer, such as a CD-ROM, a flexible disk (FD), a CD-R, or a digital versatile disk (DVD).

In addition, a configuration may also be adopted in which the electronic receipt management program P3 and the information transmission program P4, which are executed by the electronic receipt management server 9, are provided thereto by being stored on a computer that is connected to a network such as the Internet and downloaded via the network. In addition, a configuration may also be adopted in which the electronic receipt management program P3 and the information transmission program P4, which are executed by the electronic receipt management server 9, are provided or distributed thereto via a network such as the Internet.

Next, description will be given of the operations of each component that constructs the system of the embodiment.

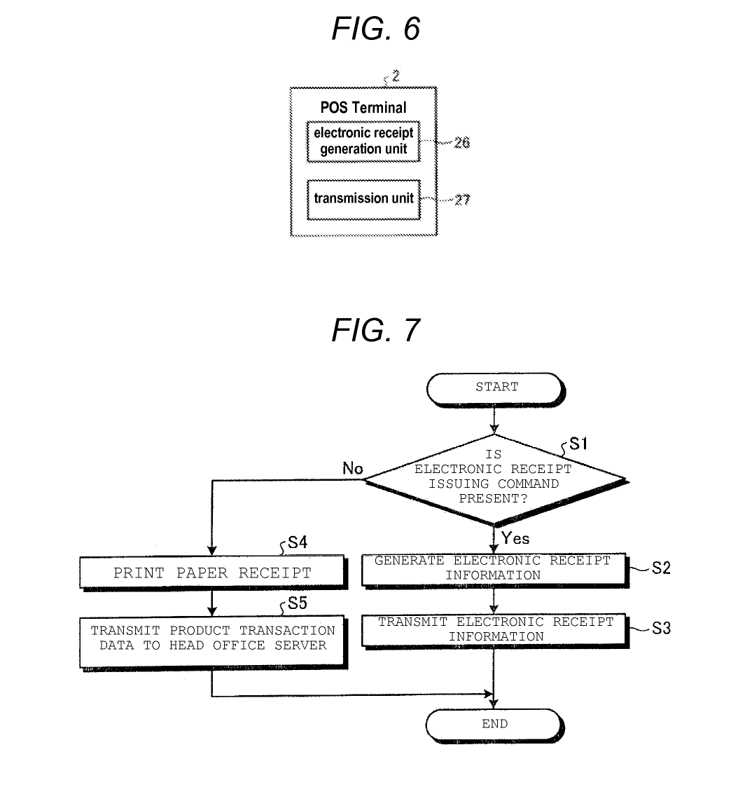

First, description will be given of an electronic receipt process, which is executed by the CPU 21 of the POS terminal operating in accordance with the electronic receipt processing program P15, with reference to the functional block diagram shown in FIG. 6 and the flow chart shown in FIG. 7.

As shown in FIG. 6, the electronic receipt processing program P15 that is executed by the POS terminal 2 is of a modular configuration containing an electronic receipt generation unit 26, which functions as the electronic receipt generation means, and a transmission unit 27, which functions as the transmission means. In terms of the actual hardware, each component described above is loaded into the memory 22 due to the CPU 21 reading out and executing the electronic receipt processing program P15 from the storage unit 23. Therefore, the electronic receipt generation unit 26 and the transmission unit 27 are generated in the memory 22.

The electronic receipt generation unit 26 correlates electronic receipt information, which contains a company code that indicates a company that owns or operates a store with the membership code of the consumer to generate the electronic receipt information.

The transmission unit 27 transmits the electronic receipt information that is generated by the electronic receipt generation unit 26 to the electronic receipt server 6, which manages the electronic receipt information based upon the company codes.

As shown in FIG. 7, when there is input of a finalizing key or the like, which starts the finalizing process of a product sale transaction, the CPU 21 (the electronic receipt generation unit 26) of the POS terminal 2 confirms the input of the membership code and whether or not an electronic receipt is to be issued. The CPU 21 then determines whether or not there is an electronic receipt issuing command, which corresponds to the payment process that corresponds to the finalizing operation (step S1).

In order to issue the electronic receipt issuing command, a method such as the one shown below may be considered, for example.

1. The clerk operates an “issue electronic receipt” button, which is provided on the input unit 31 (for example, a keyboard) of the POS terminal 2.

2. The consumer, who is the member, causes a bar-code that contains a code to be displayed on the display unit 17 of the portable terminal 8. The clerk then reads the bar-code using the input unit 31 (for example, a bar-code scanner) of the POS terminal 2.

3. The consumer, who is the member, operates an “issue electronic receipt” button, which is displayed on the customer display unit 30 so as to be possible to be pressed.

4. The consumer, who is the member, causes a bar-code that contains a code to be displayed on the display unit 17 of the portable terminal 8. The consumer, who is the member, then reads the bar-code using the input unit 31 (for example, a bar-code scanner (preferably a separate scanner from the scanner used for product registration)) of the POS terminal 2 himself or herself.

5. The consumer, who is the member, presents the company membership card for receiving the point service, and reads the company membership code of the company membership card using the input unit 31 (for example, a bar-code scanner, a magnetic card reader, NFC or the like) of the POS terminal 2. When the membership code of the electronic receipt is related to the read company membership code, it is determined that an electronic receipt issuing command is present.

When the CPU 21 (the electronic receipt generation unit 26) of the POS terminal 2 determines that there is an electronic receipt issuing command (Yes in step S1), the product transaction data is transmitted to the head office server, the CPU 21 generates the electronic receipt information by extracting the company code (the identification code of the company that owns or manages the store), the business type and business category code, the store code, the membership code of the consumer, the POS number of the POS terminal 2, the receipt number, the merchandise sales data and the like from the identification code management region 23a provided in the storage unit 23, on the basis of, separately from the product transaction data, the product information and the payment information that is registered during the payment according to the merchandise sales data processing (step S2).

Next, the CPU 21 (the transmission unit 27) of the POS terminal 2 accesses the in-store LAN 4 and the network 5 via the network interface 24, transmits the generated electronic receipt information to the electronic receipt server 6 (step S3) and ends the process. Meanwhile, when it is determined that the electronic receipt issuing command is not present (No in step S1), a paper receipt is issued by printing (step S4), the product transaction data is transmitted to the head office server (step S5), and the process is ended.

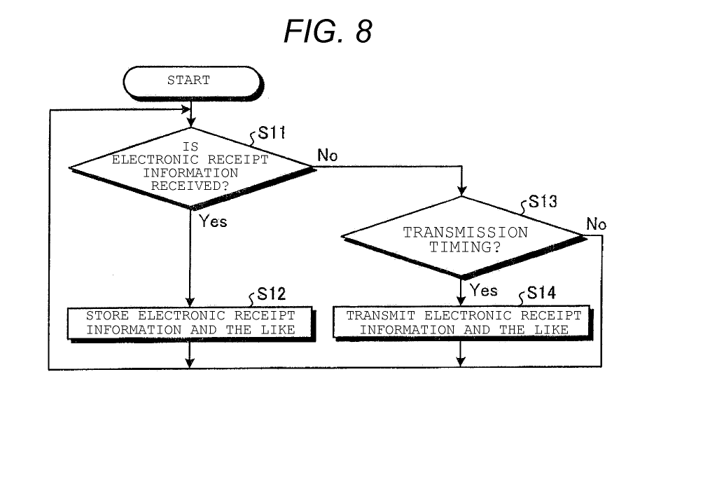

Next, description will be given of the flow of the electronic receipt management process, which is executed by the CPU 41 of the electronic receipt server 6 operating in accordance with the electronic receipt management program P1 and the flow of the information transmission process, which is executed by the CPU 41 operating in accordance with the information transmission program P2, with reference to the flow chart shown in FIG. 8.

When the CPU 41 of the electronic receipt server 6 receives the electronic receipt information, which is transmitted from the POS terminal 2, via the network interface 44 (Yes in step S11), the received information is stored in the electronic receipt management region 43a of the storage unit 43 as electronic receipt information for each company (step S12). In other words, the CPU 41 of the electronic receipt server 6 functions as an electronic receipt management processor, which manages the electronic receipt information in the storage unit 43 in correspondence with the company codes.

In addition, after the CPU 41 of the electronic receipt server 6 stores the received electronic receipt information, when a transmission timing set in advance is reached (No in step S11 and Yes in step S13), the additional information, which is managed in the information management region 43b, and the electronic receipt information, which is managed in the electronic receipt management region 43a, are transmitted to the electronic receipt management server 9 (step S14), and the process returns to step S11.

Furthermore, in the above description, the CPU 21 (the electronic receipt generation unit 26) of the POS terminal 2 is configured to generate the electronic receipt information and transmit the electronic receipt information to the electronic receipt server 6. However, the exemplary embodiment is not limited thereto. For example, the CPU 21 of the POS terminal 2 may transmit the store code, the membership code of the consumer, the POS number of the POS terminal 2, the receipt number, the merchandise sales data and the like to the electronic receipt server 6 on the basis of the product information and the payment information, which are registered during payment according to the merchandise sales data processing. Therefore, the CPU 41 of the electronic receipt server 6 may generate the electronic receipt information by adding the company code, the business type and business category code or the like to the data transmitted thereto.

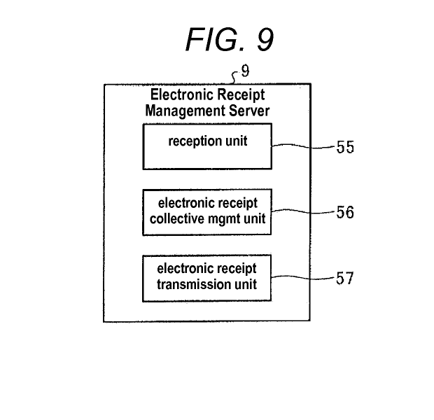

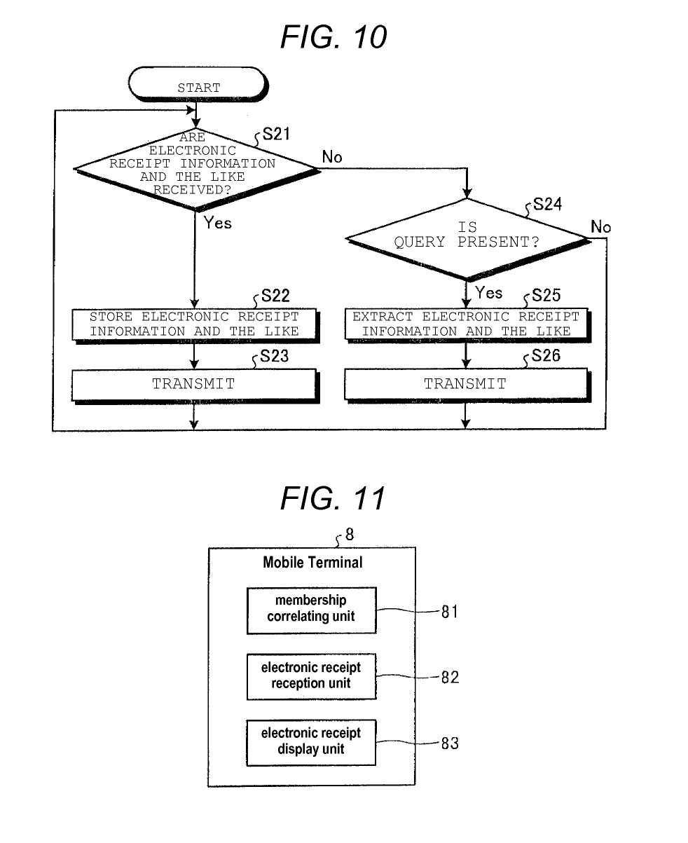

Next, description will be given of the flow of the electronic receipt management process, which is executed by the CPU 51 of the electronic receipt management server 9 operating in accordance with the electronic receipt management program P3 and the flow of the product information transmission process, which is executed by the CPU 51 operating in accordance with the information transmission program P4, with reference to the functional block diagram shown in FIG. 9 and the flow chart shown in FIG. 10.

As shown in FIG. 9, the electronic receipt management program P3 and the information transmission program P4 that are executed by the electronic receipt management server 9 are of a modular configuration containing a reception unit 55 that functions to receive electronic receipt information, an electronic receipt batch management unit 56 that functions to execute the electronic receipt collective management process and an electronic receipt transmission unit 57 that functions to transmit electronic receipts. In terms of the actual hardware, each component described above is loaded into the memory 52 due to the CPU 51 reading out and executing the electronic receipt management program P3 and the information transmission program P4 from the storage unit 53. Therefore, the reception unit 55, the electronic receipt batch management unit 56 and the electronic receipt transmission unit 57 are generated in the memory 52.

The reception unit 55 receives the electronic receipt of a company. The electronic receipt information contains the company code that indicates the company that owns or manages a store where receipt information is electronically processed instead of issuing a printed receipt.

The electronic receipt batch management unit 56 stores the electronic receipt information, which is received using the reception unit 55, by company, in the electronic receipt management region 53a of the storage unit 53, and manages the electronic receipt information in batches.

The electronic receipt transmission unit 57 acquires the electronic receipt information, which is correlated with the membership code and contains at least one or more company codes, from the electronic receipt management region 53a and transmits the acquired electronic receipt information to the portable terminal 8, which is correlated with the membership code of a designated consumer.

As shown in FIG. 10, the CPU 51 (the reception unit 55) of the electronic receipt management server 9 determines whether or not the electronic receipt information and the additional information, which are transmitted from the electronic receipt server 6 of each company, are received via the network interface 54 (step S21).

When the electronic receipt information and the additional information are received (Yes in step S21), the CPU 51 (the electronic receipt batch management unit 56) of the electronic receipt management server 9 stores the electronic receipt information and the additional information of the various companies in the electronic receipt management region 53a of the storage unit 53 in batches (step S22).

In addition, after the CPU 51 (the electronic receipt transmission unit 57) of the electronic receipt management server 9 stores the electronic receipt information and the additional information in the electronic receipt management region 53a in batches, the CPU 51 transmits the electronic receipt information and the additional information to the portable terminal 8 (step S23) and returns to step S21. Furthermore, when the transmission of the electronic receipt information completes, the transmission results of the electronic receipt information may be managed by storing a flag that signifies the completion of the transmission with respect to the electronic receipt information in the electronic receipt management region 53a.

In addition, when there is a query of the electronic receipt information from the portable terminal 8 (No in step S21 and Yes in step S24), the CPU 51 (the electronic receipt transmission unit 57) of the electronic receipt management server 9 extracts the additional information and the electronic receipt information, which are managed in the electronic receipt management region 53a, according to the content of the query of the electronic receipt information (step S25), subsequently transmits the queried additional information and the electronic receipt information to the portable terminal (step S26) and returns to step S21.

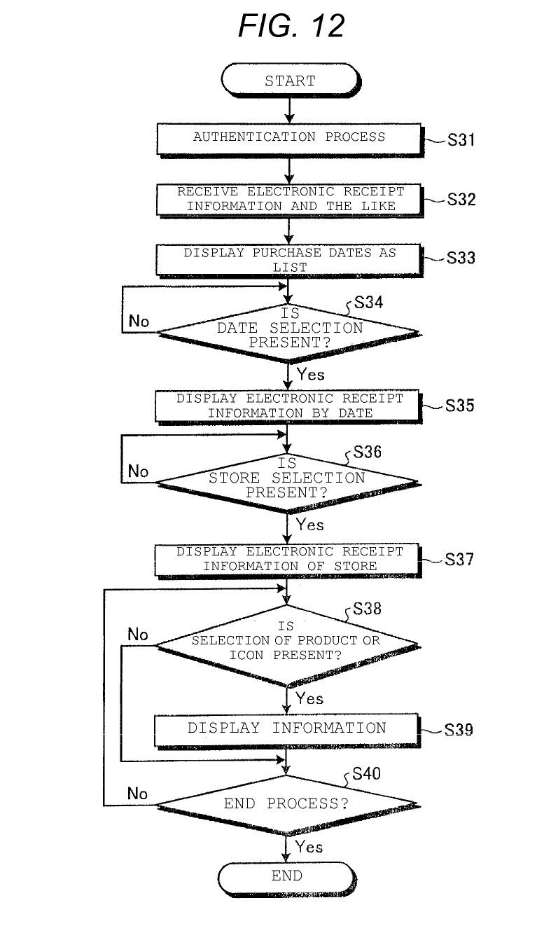

Next, description will be given of the flow of the electronic receipt receiving process, which is executed by the CPU 11 of the portable terminal 8 operating in accordance with the electronic receipt handling program P11 and the flow of the electronic receipt viewing process, which is executed by the CPU 11 operating in accordance with the electronic receipt viewing program P12, with reference to the functional block diagram shown in FIG. 11 and the flow chart shown in FIG. 12.

As shown in FIG. 11, the electronic receipt handling program P11 and the electronic receipt viewing program P12 that are executed by the portable terminal 8 are of a modular configuration containing a membership correlating unit 81, which functions as the membership correlating means, an electronic receipt reception unit 82, which functions as the electronic receipt reception means, and an electronic receipt display unit 83, which functions as the electronic receipt display means. In terms of the actual hardware, each component described above is loaded into the memory 12 due to the CPU 11 reading out and executing the electronic receipt handling program P11 and the electronic receipt viewing program P12 from the storage unit 13. Therefore, the membership association unit 81, the electronic receipt reception unit 82 and the electronic receipt display unit 83 are generated in the memory 12.

The membership association unit 81 correlates the membership code of a designated consumer with the electronic receipt information.

The electronic receipt reception unit 82 receives the electronic receipt information which is correlated with the membership code and contains at least one or more company codes, from the electronic receipt management server 9, which manages the electronic receipt information in batches.

The electronic receipt display unit 83 sorts the electronic receipt information, which is received by the electronic receipt reception unit 82, by company code, and displays the electronic receipt information on the display unit 17.

As shown in FIG. 12, first, the CPU 11 (the membership association unit 81) of the portable terminal 8 accesses the electronic receipt management server 9 and executes an authentication process using the input of the membership code and the password (step S31). Accordingly, the portable terminal 8 and the membership code of a designated consumer are correlated with one another.

After the authentication step is completed, the CPU 11 (the electronic receipt reception unit 82) of the portable terminal 8 receives the additional information and the electronic receipt information, which are managed in the electronic receipt management region 53a corresponding to the input membership code (step S32). Furthermore, the reception of the additional information and the electronic receipt information may also be received using electronic mail (email).

Next, the CPU 11 (the electronic receipt display unit 83) of the portable terminal 8 displays the purchase dates contained in the electronic receipt information on the display unit 17 as a list (step S33). The portable terminal 8 prompts the user, who is the consumer, to select the information by displaying the purchase dates on the display unit 17 as a list in this manner.

When the CPU 11 of the portable terminal 8 determines that a date is selected by the user tapping thereon (Yes in step S34), the CPU 11 displays the electronic receipt information, which corresponds to the selected date, on the display unit 17 (step S35).

When the CPU 11 of the portable terminal 8 determines that a store is selected by the user on the selected date (Yes in step S36), the CPU 11 displays the electronic receipt information, which corresponds to the store selected by date, on the display unit 17 (step S37).

Here, when the user selects an appropriate product or an icon, which is correlated with a product, (Yes in step S38), the CPU 11 (the electronic receipt display unit 83) of the portable terminal 8 connects to the network 5 via the network interface 14, acquires various information from the network 5 on the basis of the access information, which is correlated with the selected product or icon, and displays the information on the display unit 17 (step S39).

For example, when, as the access information in relation to the product a, a home page associated with the product is set as a product information link, the home page, which is correlated with the product, is displayed on the display unit 17 when the desired product is selected.

When the end of the electronic receipt viewing process is declared from the input unit 18 (Yes in step S40), the CPU 11 of the portable terminal 8 ends the process.

When the end of the electronic receipt viewing process is not declared from the input unit 18 (No in step S40), the CPU 11 of the portable terminal 8 returns to step S38 and waits for the selection of a product or an icon that is correlated with a product.

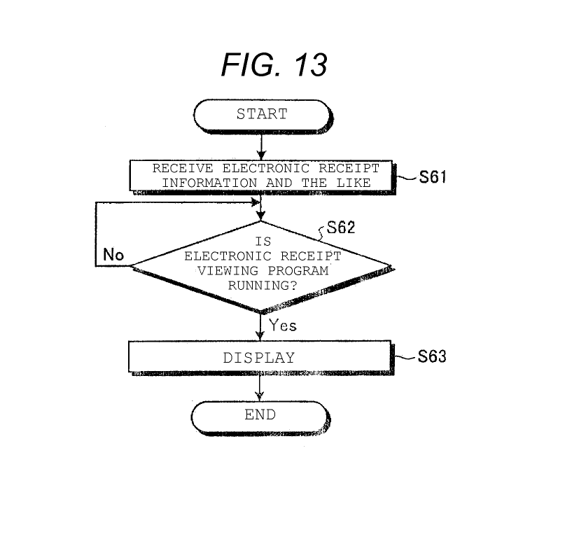

In addition, as described in step S23 of FIG. 10 described above, a case in which, instead of accessing the electronic receipt management server 9 from the portable terminal 8, the portable terminal 8 receives the electronic receipt information and the additional information from the electronic receipt management server 9 is also described with reference to the flow chart of FIG. 13.

The CPU 11 (the electronic receipt reception unit 82) of the portable terminal 8 receives the electronic receipt information and the additional information from the electronic receipt management server 9 (step S61).

Subsequently, when the electronic receipt viewing program P12 is run (Yes in step S62), the CPU 11 (the electronic receipt display unit 83) of the portable terminal 8 relates the received electronic receipt information and additional information with the company code and displays the electronic receipt information and the additional information (step S63).

Furthermore, the electronic receipt information may also be shared between members of the electronic receipt system. By relating a plurality of the membership codes, the merchandise sales data of the products that each individual purchases may be shared with, for example, a family, a group, a department of a company or the like.

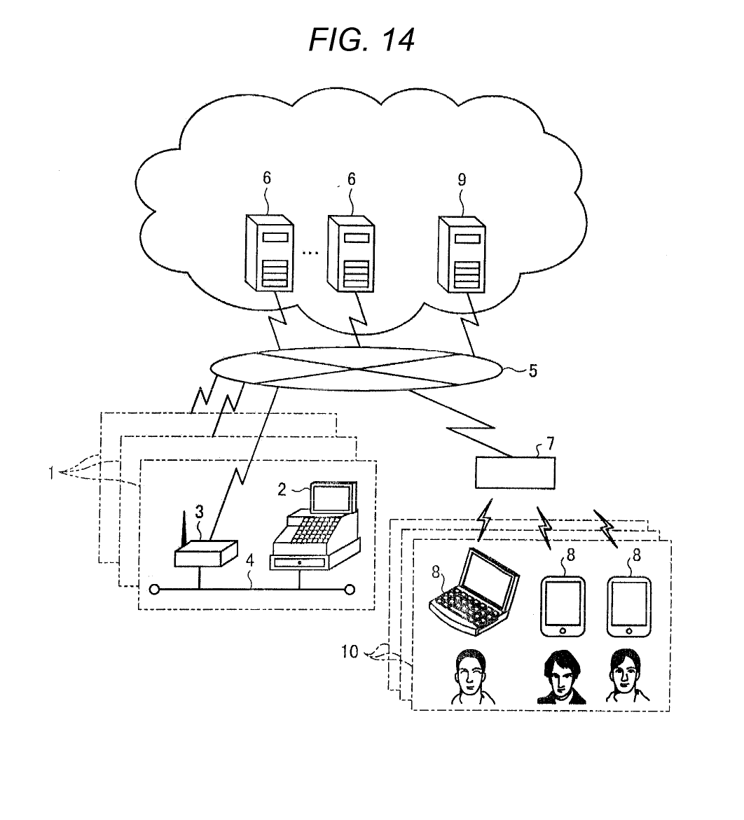

FIG. 14 is a configuration diagram showing the overall configuration of a case in which merchandise sales data is shared in an electronic receipt system according to an embodiment. As shown in FIG. 14, a group 10 is provided for everyone of the portable terminals 8 (three in FIG. 14, however, more or less than three portable terminals 8 may also be provided) of individuals sharing sales data.

The group 10 is configured by (1) the membership code of a group representative, (2) the membership codes of the participants participating in the group and (3) the portable terminals 8 of the representative and the participants participating in the group.

The information is stored in a specific region of the storage unit 53 of the electronic receipt management server 9.

The data of the sharing process and the concealing process, which is described below, is also stored in a specific region of the storage unit 53 of the electronic receipt management server 9.

Description will be given in detail. For example, the electronic receipt information is stored in the electronic receipt management region 53a of the storage unit 53 of the electronic receipt management server 9. Inside the electronic receipt information, a receipt flag region, a store flag region or a product flag region, which store flags to be shared relating respectively to the receipt, the store or the product to be shared, are further added to the electronic receipt management region 53a. The receipt, the store or the product to be shared is identified by confirming the flags. Furthermore, the member, the receipt, the store or the product to be concealed is also identified in the same manner. In other words, a flag region is added to the electronic receipt management region 53a of the storage unit 53 of the electronic receipt management server 9.

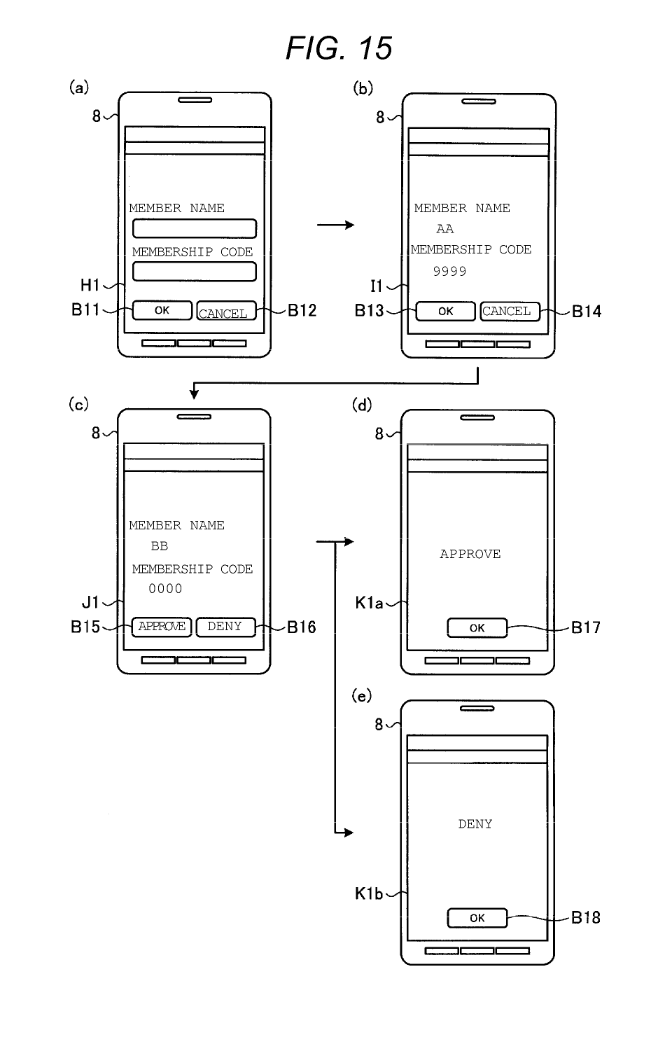

Here, description is given of a setting example of the group 10 that shares the merchandise sales data as described above using the drawings. Here, FIGS. 15A to 15E are transition diagrams showing a transition example of a screen in a setting registration of the group 10 that shares the merchandise sales data.

(1) First, the consumer, who is the representative of the group 10, logs in by accessing a specific URL from the portable terminal 8, which the consumer owns, or by using an application, which is installed on the portable terminal 8. Subsequently, the representative accesses the screen in which the settings of the group 10, which determines sharing of merchandise sales data, are registered. When accessed, the portable terminal 8 is caused to display a setting registration screen H1 of the group 10. The setting registration screen H1 is a screen in which the member name and the membership code of the consumer, who the representative desires to participate in the group 10, is registered. The representative inputs the member name and the membership code of the electronic receipt of a consumer who the representative desires to have participated in the group 10, and presses an OK button B11. In addition, when a cancel button B12 is pressed, the portable terminal 8 erases the setting registration screen H1 of the group 10 and cancels the setting registration.

(2) When the OK button B11 is pressed, the portable terminal 8 displays a setting confirmation screen I1 (FIG. 15B). The setting confirmation screen I1 is a screen for confirming the registration content of the setting registration screen H1. When an OK button B13 is pressed, the portable terminal 8 transmits the registration content to the electronic receipt management server 9. In addition, when a cancel button B14 is pressed, the portable terminal 8 displays the setting registration screen H1 again.

(3) The electronic receipt management server 9 receives the registration content from the portable terminal 8 in (2), and queries the consumer registered in (2) whether or not the consumer wishes to participate in the group 10. The portable terminal 8 of the consumer that received the query displays a participation registration screen J1 (FIG. 15C). The participation registration screen J1 is a screen which displays the fact that the consumer is requested to participate in the group 10. When an approve button B15 is pressed, the portable terminal 8 transmits a response indicating that participation to the group 10 is approved to the electronic receipt management server 9. Meanwhile, when a deny button B16 is pressed, the portable terminal 8 transmits a response indicating that participation to the group 10 is denied to the electronic receipt management server 9.

(4) The electronic receipt management server 9 transmits the response to the representative. When the response indicates an approval, the portable terminal 8 of the representative displays an approval screen K1a. When an OK button B17 is pressed, the approval screen K1a is erased, and the group registration ends (FIG. 15D). Meanwhile, when the response indicates a denial, the portable terminal 8 of the representative displays a denial screen K1b (FIG. 15B). When an OK button B18 is pressed, the denial screen K1b is erased, and the group registration ends.

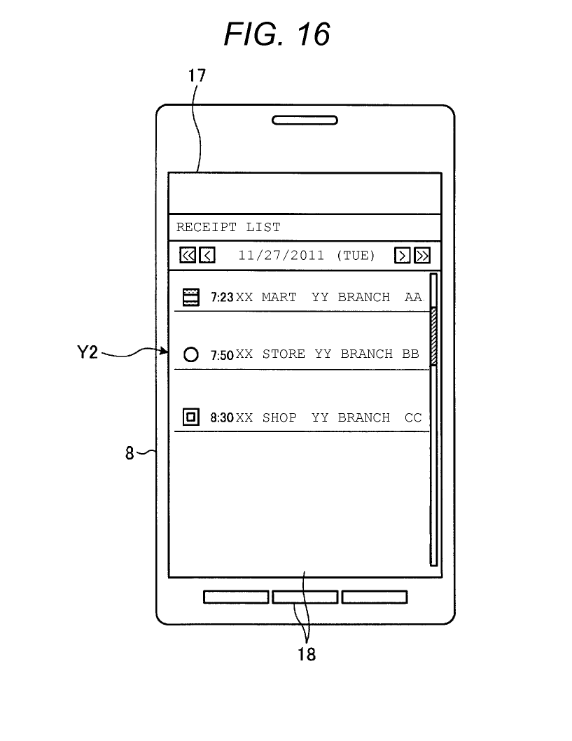

FIG. 16 is a front view showing a display example Y2 of the portable terminal. As shown in FIG. 16, the display example Y2 displays the stores of the various companies at which shopping is performed by the consumer, who is a member of the group 10, by date in list format. More specifically, the display example Y2 displays the electronic receipt information in the time series order in which it was received, and the company trademark, the transaction time, the company name, the store name and the member name are displayed. In addition, the CPU 11 (the electronic receipt display unit 83) of the portable terminal 8 performs display such that, from among the store information by date that is displayed as a list, a store may be selected by the desired date using a cursor, which follows the input of the input unit 18.

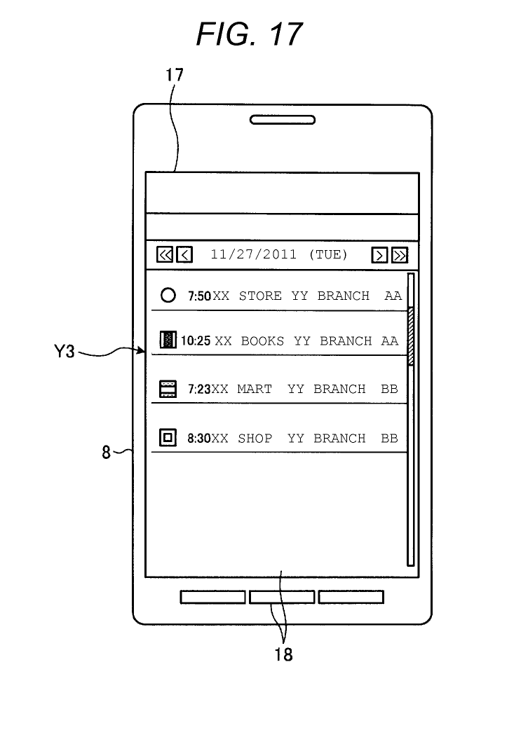

FIG. 17 is a front view showing a display example Y3 of the portable terminal. By touching the member name of the display example Y3 as shown in FIG. 17, the usage history of the member names is sorted in time series order and displayed as a list. By displaying the members as a list in this manner, the usage status is easy to understand.

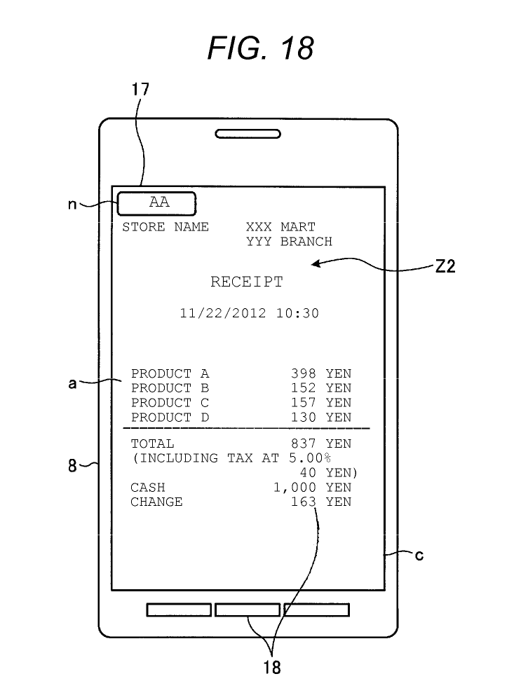

FIG. 18 is a front view showing a display example Z2 in the display unit 17 of the portable terminal 8. As shown in FIG. 18, the display example Z2 displays the electronic receipt information of the desired store on the desired date at which shopping is performed by the consumer, who is a member of the group 10. The display example Z2 is of a similar layout to that of a paper receipt due to analyzing the electronic receipt information, and an icon n, which represents the member name of the member that performed shopping, is displayed. In addition, FIG. 18 shows that AA performed shopping.

Furthermore, when the merchandise sales data is shared between the members of the electronic receipt system, conditions may be added. By adding conditions to the sharing, privacy may be protected, for example.

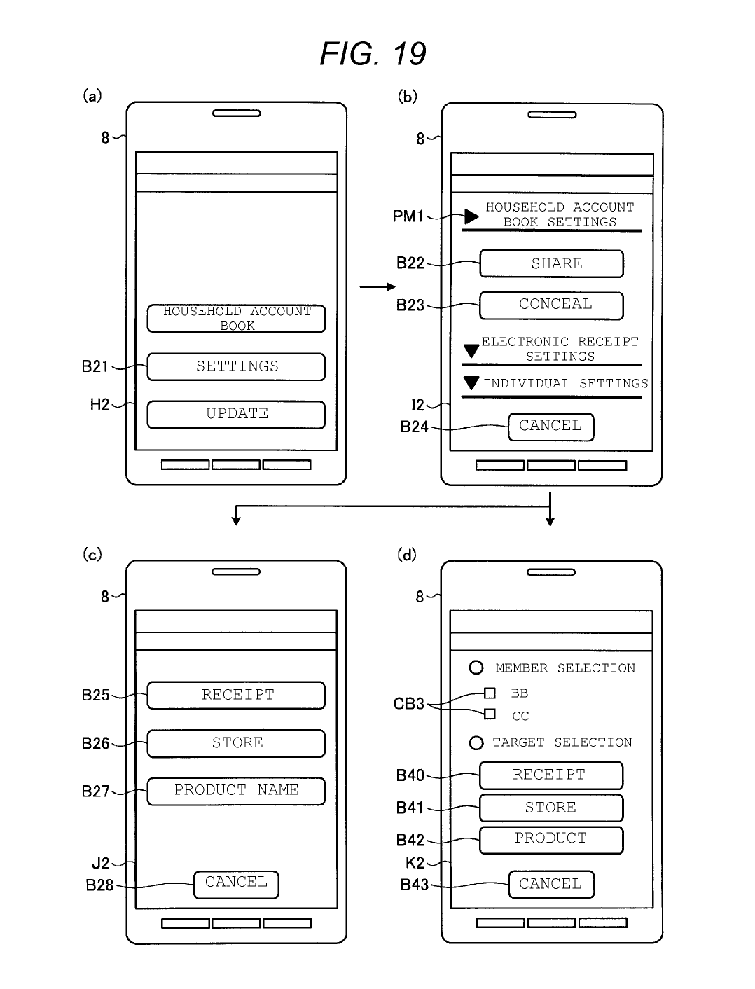

Here, description is given of a setting example of condition adding relating to the sharing of the merchandise sales data described above using the drawings. Here, FIGS. 19A to 19D are transition diagrams showing a transition example of a screen in a setting registration in which setting is performed in relation to the sharing of the merchandise sales data.

(1) First, the member of the group 10 logs in by accessing a specific URL from the portable terminal 8 owned by the member, or by using an application, which is installed on the portable terminal 8. When the member logs in, the portable terminal 8 displays an initial screen H2 (FIG. 19A). The initial screen H2 displays buttons for performing various operations. The member presses a settings button B21, which performs setting in relation to the sharing of the merchandise sales data. In FIG. 19A a household account book button, the settings button B21 and an update button are displayed. The household account book is a button that causes a household account book, which is generated from the electronic receipt information, for example, to be displayed. The update button is a button that is used when updating the content of the various buttons described above, for example.

(2) When the settings button B21 is pressed, the portable terminal 8 displays a setting screen I2. The setting screen I2 is a screen for performing various settings. The setting screen I2 includes a pull-down menu for performing household account book settings PM1, electronic receipt settings, individual settings and the like. The household account book settings PM1 are tapped when performing setting in relation to the sharing of the merchandise sales data. The electronic receipt settings are tapped when performing the various settings in relation to the electronic receipt. The individual settings are tapped when performing setting of the display method and the like of the portable terminal 8. When the household account book settings PM1 is tapped, the portable terminal 8 is caused to display a share button B22 (icon) and a conceal button B23 (icon), which were not being displayed, such that the buttons are pulled out (FIG. 19B). The share button B22 is a button to be pressed when the product of the electronic receipt is to be registered to the shared household account book of the merchandise sales data. The conceal button B23 is a button for setting the electronic receipt not to be displayed in relation to a specific member, even when the electronic receipt is registered to the shared household account book of the merchandise sales data. A cancel button B24 is a button which, when pressed, causes the initial screen H2 to be displayed without performing setting.

(3) When the share button B22 is pressed, the portable terminal 8 is caused to display a share screen J2, which is a setting means (FIG. 19C). Meanwhile, when the conceal button B23 is pressed, the portable terminal 8 is caused to display a conceal screen K2, which is a privacy setting means (FIG. 19D).

The term “share” means to share the merchandise sales data of the electronic receipt information with the members of the group 10. More specifically, the term “share” means to register a specific product from the merchandise sales data of the electronic receipt information of the shopping performed by a member to the shared household account book of the merchandise sales data. In addition, by setting a social networking service (SNS) in advance, the sharing may submit the merchandise sales data to the set SNS. Accordingly, the members may understand the shopping performed by one another. In addition, for example, when sharing is performed by a family, the family budget management may be performed easily.

Concealment settings are settings in which specific merchandise sales data is kept private from a set specific member by setting the member and the merchandise sales data or the like of the electronic receipt information. More specifically, the consumer, who is a member of the group 10, selects a member of the group 10. In addition, the consumer selects a specific electronic receipt, all of the electronic receipts issued from a specific store or a specific product name to conceal from the selected member. Accordingly, the specific merchandise sales data or the like is kept private from the specifically chosen member. Accordingly, for example, an invasion of privacy caused by excessive interference may be prevented.

First, description will be given of a setting example of the share screen J2 using the drawings. Here, description returns to FIG. 19C. The share screen J2 includes a receipt button B25, a store button B26, a product name button B27 and a cancel button B28. The receipt button B25 is a button which is used when searching for a product or the like to share from a list of receipts. The store button B26 is a button which is used when searching for a product or the like to share from a list of stores. The product name button B27 is a button which is used when searching for a product or the like to share from the product name. A cancel button B28 is a button which, when pressed, causes the setting screen I2 to be displayed without performing setting.

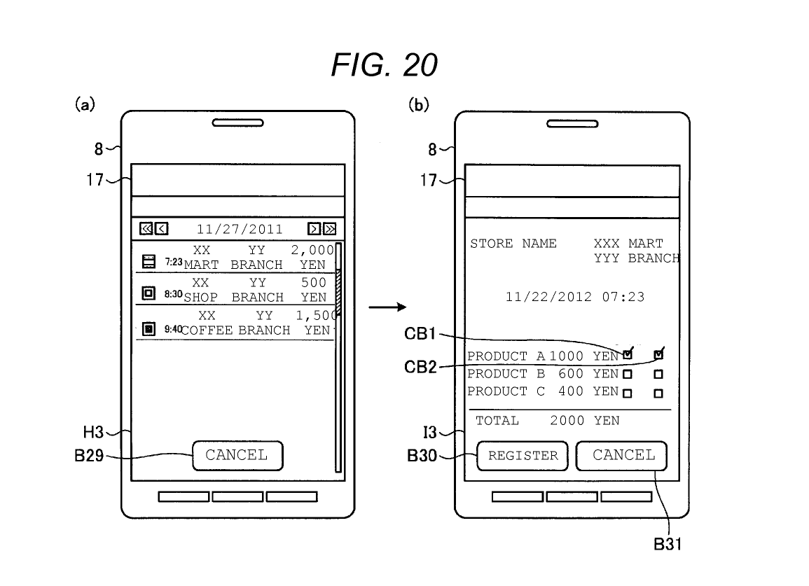

First, description will be given of a case in which the receipt button B25 is pressed. Here, FIGS. 20A and 20B are transition diagrams showing a transition example of a screen in a case of searching for a product or the like to be shared from a list of receipts.

(1) When the receipt button B25 is pressed, the portable terminal 8 is caused to display a receipt selection screen H3 (FIG. 20A). The receipt selection screen H3 displays the electronic receipts of the shopping performed by the member that owns the portable terminal 8, which accesses the electronic receipt management server 9, by date in a list order. When the member selects the electronic receipt to share by tapping thereon, a product selection screen I3 is displayed. A cancel button B29 is a button which, when pressed, causes the share screen J2 to be displayed.

(2) The product selection screen I3 is a screen for selecting the product to be shared (FIG. 20B). The product selection screen I3 includes a branch name, the store name, the transaction date, a list of the purchased products and the total monetary amount of the purchased products. In addition, the product selection screen I3 includes a household account book checkbox CB1 and an SNS checkbox CB2 for each product. In addition, the product selection screen I3 includes a register button B30 and a cancel button B31. The household account book checkbox CB1 is a checkbox to be checked when registering the selected products to the shared household account book of the merchandise sales data. The SNS checkbox CB2 is a checkbox to be checked when submitting the merchandise sales data to the SNS, which is set in advance. The register button B30 is a button to be pressed when registering the setting content. The cancel button B31 is a button which, when pressed, causes the receipt selection screen H3 to be displayed without performing setting. The member selects and registers the product to be shared from the product selection screen I3. FIG. 20B shows, in relation to a product A, that the merchandise sales data is shared with the household account book and the SNS.

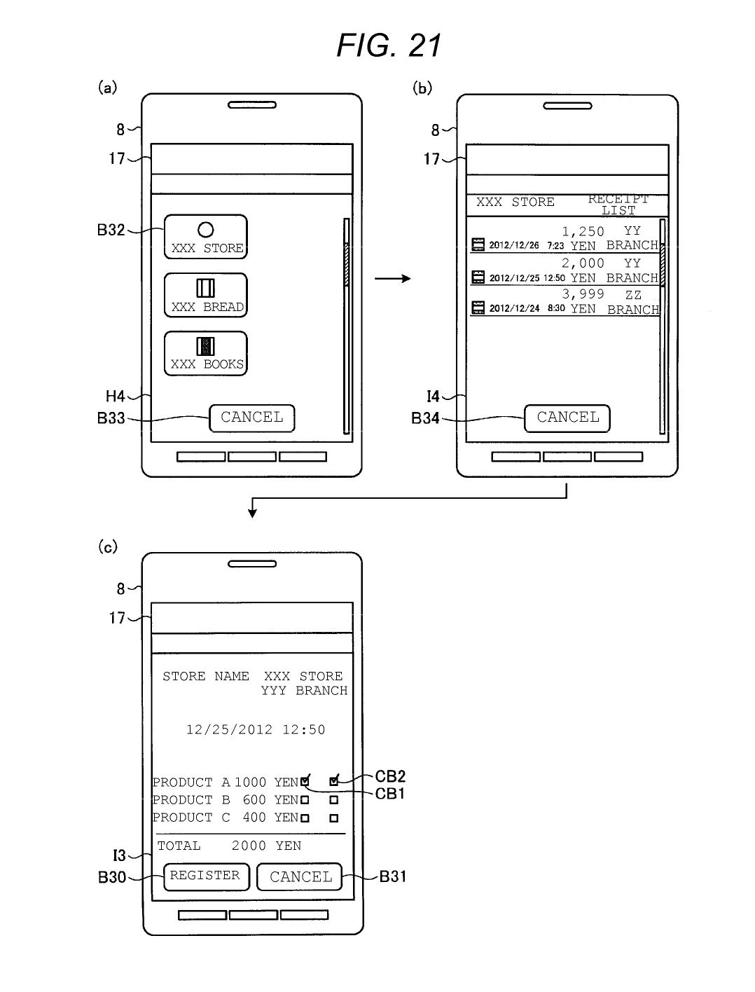

Next, description will be given of a case in which the store button B26 is pressed. Here, FIGS. 21A to 21C are transition diagrams showing a transition example of a screen in a case of searching for a product or the like to be shared from a list of stores.

(1) When the store button B26 is pressed, the portable terminal 8 is caused to display a company selection screen H4 (FIG. 21A). The company selection screen H4 displays a list of the stores at which the shopping is performed by the member that owns the portable terminal 8, which accesses the electronic receipt management server 9. The company selection screen H4 includes a company button B32 and a cancel button B33. The member taps the company button B32 of the company that issued the electronic receipt of the product to be shared. The cancel button B33 is a button which, when pressed, causes the share screen J2 to be displayed.

(2) When the company button B32 is tapped, the portable terminal 8 is caused to display a company receipt list screen (FIG. 21B). The company receipt list screen I4 displays the electronic receipts of the shopping performed at the selected company by the member that owns the portable terminal 8, which accesses the electronic receipt management server 9, as a list. When the member selects the electronic receipt by tapping thereon, the product selection screen I3 is displayed (FIG. 21C). The product selection screen I3 is of a similar screen layout to that of the product selection screen I3 displayed from the receipt button B25. Furthermore, a cancel button B34 is a button which, when pressed, causes a company selection screen H4 to be displayed without performing setting.

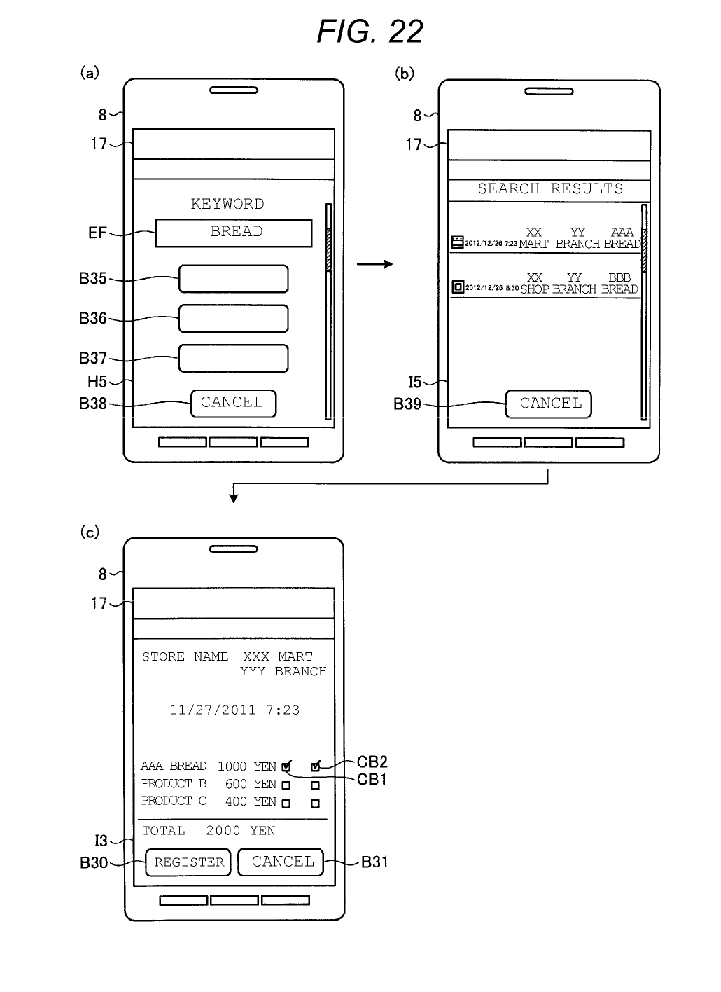

Next, description will be given of a case in which the product name button B27 is pressed. Here, FIGS. 22A to 22C are transition diagrams showing a transition example of a screen in a case of searching for a product or the like to be shared with a product name.

(1) When the product name button B27 is pressed, the portable terminal 8 is caused to display a product name selection screen H5 (FIG. 22A). The product name selection screen H5 is a screen for selecting the desired product by searching for the product name to be shared. The product name selection screen H5 includes an entry field EF, a begins-with search button B35, an ends-with search button B36, a fuzzy search button B37 and a cancel button B38. The entry field EF is a field for inputting the product name to be searched for. The begins-with search button B35 is a button which is used when extracting product names where the search characters input in the entry field EF match the beginning of the product name. The ends-with search button B36 is a button which is used when extracting product names where the search characters input in the entry field EF match the end of the product name. The fuzzy search button B37 is a button which is used when, even when the search characters input in the entry field EF do not completely match the product name, the product names are extracted based on defined rules. Well-known technology is used for the search method of the fuzzy search. Furthermore, the cancel button B38 is a button which, when pressed, causes the share screen J2 to be displayed.

(2) After the search characters are input in the entry field EF, when one of the begins-with search button B35, the ends-with search button B36 and the fuzzy search button B37 is pressed, the portable terminal 8 is caused to display a searched receipt list screen I5 (FIG. 22B). The searched receipt list screen I5 displays the electronic receipts in which the product of the product name searched for by the member, who owns the portable terminal 8 that accesses the electronic receipt management server 9, is present as a list. The searched receipt list screen I5 displays the purchase date and time of the product, the store from which the purchase was made, the store name of the store from which the purchase was made and the product names of products which match the search conditions. When the member selects the electronic receipt by tapping thereon, the product selection screen I3 is displayed. The product selection screen I3 is of a similar screen layout to that of the product selection screen I3 displayed by pressing the receipt button B25. Furthermore, a cancel button B39 is a button which, when pressed, causes the company selection screen H4 to be displayed without performing setting.

Furthermore, in the above description, the merchandise sales data to be shared is selected per product of the electronic receipt. However, a system may also be adopted in which all of the merchandise sales data of the selected electronic receipt is shared. Alternatively, a system may also be adopted in which all of the merchandise sales data of the electronic receipts issued from the selected company is shared. Alternatively, a system may also be adopted in which all of the merchandise sales data of the selected product name is shared.

Next, description will be given of a setting example after display of the conceal screen K2 using the drawings. FIG. 19D shows the conceal screen K2 when the conceal button B23 is pressed. The conceal screen K2 includes a member selection checkbox CB3, a receipt button B40, a store button B41, a product button B42 and a cancel button B43.

A member of the group is displayed beside each member selection checkbox CB3, which is a checkbox for selecting the member from which to conceal. The receipt button B40 is a button to be pressed when setting a specific electronic receipt to be concealed. The store button B41 is a button to be pressed when setting all of the electronic receipts issued from a specific store to be concealed. The product button B42 is a button to be pressed when setting the electronic receipts of a specific product name to be concealed. The cancel button B43 is a button which, when pressed, causes the setting screen I2 to be displayed without performing setting.

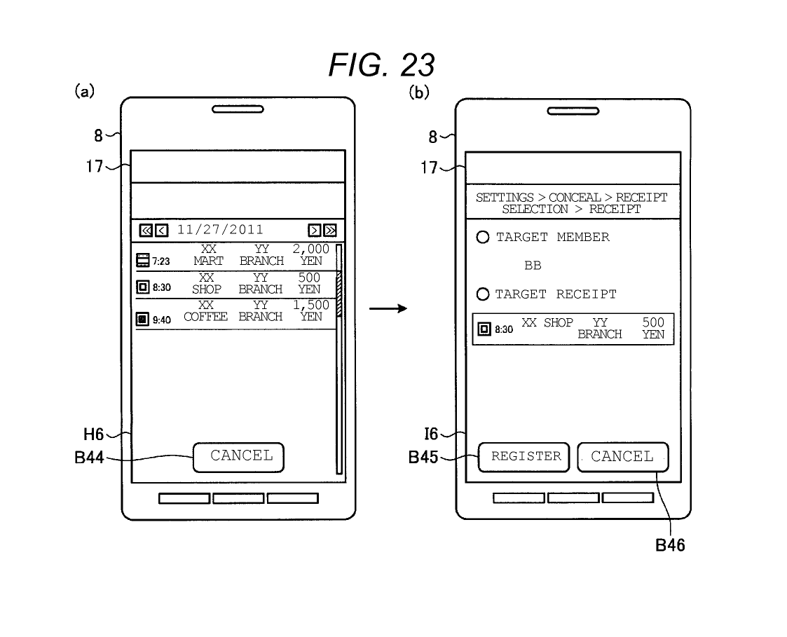

First, description will be given of a case in which the receipt button B40 is pressed. Here, FIGS. 23A and 23B are transition diagrams showing a transition example of a screen in a case of searching for an electronic receipt or the like to be concealed from a list of electronic receipts.

(1) When the receipt button B40 is pressed, the portable terminal 8 is caused to display a concealed receipt selection screen H6 (FIG. 23A). The concealed receipt selection screen H6 displays the electronic receipts of the shopping performed by the member that owns the portable terminal 8, which accesses the electronic receipt management server 9, by date as a list. When the member selects the electronic receipt by tapping thereon, a concealed receipt confirmation screen I6 is displayed. A cancel button B44 is a button which, when pressed, causes the conceal screen K2 to be displayed.

(2) The concealed receipt confirmation screen I6 displays the target member, from which to conceal a target receipt, and the target receipt (FIG. 23B). In addition, the concealed receipt confirmation screen I6 includes a register button B45 and a cancel button B46. When the register button B45 is pressed, the portable terminal 8 registers the display content. When the cancel button B46 is pressed, the portable terminal 8 is caused to display the concealed receipt selection screen H6 without performing the registration.

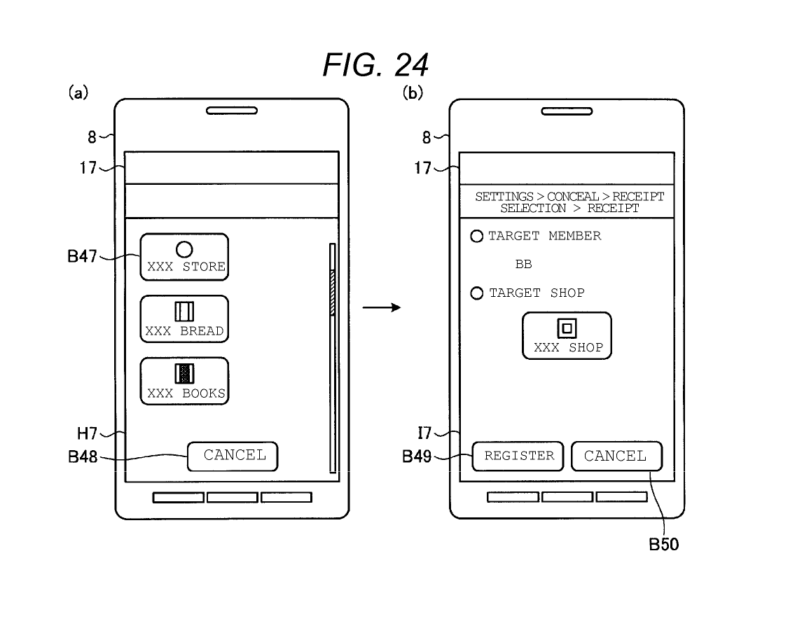

Next, description will be given of a case in which the store button B41 is pressed. Here, FIGS. 24A and 24B are transition diagrams showing a transition example of a screen in a case of searching for a company or the like to be concealed from a list of stores.

(1) When the store button B41 is pressed, the portable terminal 8 is caused to display a concealed company selection screen H7 (FIG. 24A). The concealed company selection screen H7 displays a list of the stores at which shopping is performed by the member that owns the portable terminal 8, which accesses the electronic receipt management server 9. The concealed company selection screen H7 includes a company button B47 and a cancel button B48. The member taps the company button B47 of the company to be concealed. The cancel button B48 is a button which, when pressed, causes the conceal screen K2 to be displayed.

(2) A concealed company confirmation screen I7 displays the target member, from which to conceal a target store, and the target store (FIG. 24B). In addition, the concealed company confirmation screen I7 includes a register button B49 and a cancel button B50. When the register button B49 is pressed, the portable terminal 8 registers the display content. When the cancel button B50 is pressed, the portable terminal 8 is caused to display the concealed company selection screen H7 without performing the registration.

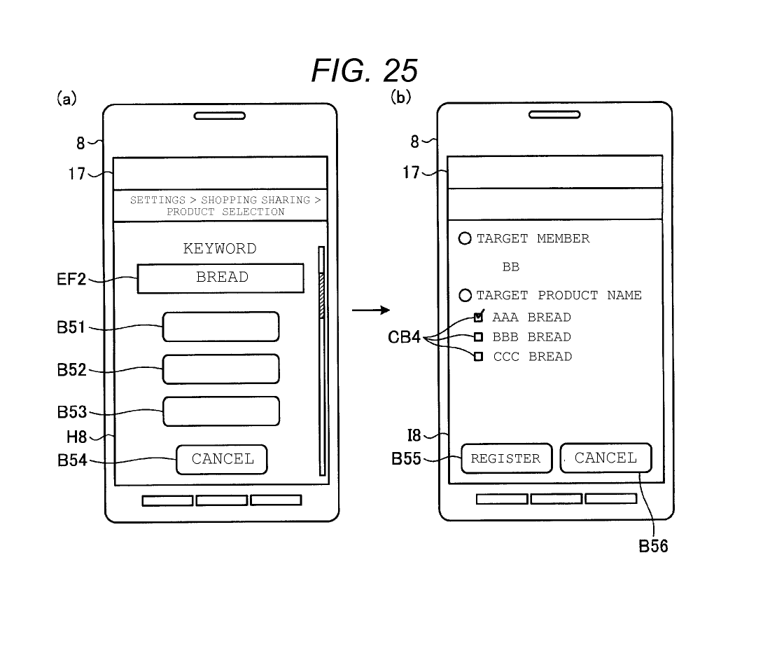

Next, description will be given of a case in which the product button B42 is pressed. Here, FIGS. 25A and 25B are transition diagrams showing a transition example of a screen in a case of searching for a product or the like to be concealed with a product name.

(1) When the product button B42 is pressed, the portable terminal 8 is caused to display a concealed product selection screen H8 (FIG. 25A). The concealed product selection screen H8 is a screen for selecting the desired product by searching for the product name to be concealed. The concealed product selection screen H8 includes an entry field EF2, a begins-with search button B51, an ends-with search button B52, a fuzzy search button B53 and a cancel button B54. The entry field EF2 is a field for inputting the product name to be searched for. The begins-with search button B51 is a button which is used when extracting product names where the search characters input in the entry field EF2 match the beginning of the product name. The ends-with search button B52 is a button which is used when extracting product names where the search characters input in the entry field EF2 match the end of the product name. The fuzzy search button B53 is a button which is used when, even when the search characters input in the entry field EF2 do not completely match the product name, the product names are extracted based on defined rules. Well-known technology is used for the search method of the fuzzy search.

(2) After the keywords are input in the entry field EF2, when one of the begins-with search button B51, the ends-with search button B52 and the fuzzy search button B53 is pressed, the portable terminal 8 is caused to display a concealed product list screen I8 (FIG. 25B). The concealed product list screen I8 displays the target member, from which to conceal a target product, and the target product name. The target product name displays the product name which matches the search characters of the entry field EF2 using the search method of the pressed button. A concealed product selection checkbox CB4 is present on the right side of the product name. The concealed product selection checkbox CB4 is a checkbox for setting the product of the selected product name to be concealed. Furthermore, the concealed product list screen I8 includes a register button B55 and a cancel button B56. When the register button B55 is pressed, the portable terminal 8 registers the display content. When the cancel button B56 is pressed, the portable terminal 8 is caused to display the concealed product selection screen H8 without performing the registration.

As described above, by relating the membership code of the electronic receipt of each consumer with each of the groups 10, the members of the groups 10 may share the merchandise sales data of the members. Furthermore, the merchandise sales data of a member may also be shared from before the member joins the group 10.

As described above, by sharing the merchandise sales data of the members, the convenience of managing the merchandise sales data by the group 10 is improved.

In addition, since the merchandise sales data of the members may be viewed, a member may understand whether or not a family member is eating a balanced diet, even when the family member is separated by working, or the like, and thus away from the family. In addition, the system may also be used to confirm that an elderly person is alive. Furthermore, since the merchandise sales data may be understood in units of family, companies may use the merchandise sales data as new marketing data.

In this manner, according to the electronic receipt system of the embodiment, since, unlike the electronic receipt system in units of company of the related art, the electronic receipt system may be implemented to exceed the boundary of companies, and the introduction of the electronic receipts may be promoted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic receipt system, comprising:
an electronic receipt generation unit configured to generate electronic receipt information relating to merchandise sales data, and correlate the electronic receipt information with a code of a consumer;
an electronic receipt management unit configured to associate the electronic receipt information generated by the electronic receipt generation unit with a company code, and store the electronic receipt information in a storage unit;
an electronic receipt collective management unit configured to manage the electronic receipt information collectively for a plurality of the companies, each associated with a different company code;
a group associating unit configured to define a group by associating codes of different consumers with the group;
an electronic receipt transmission unit configured to transmit the electronic receipt information to information processing devices that are correlated with the codes that are associated with the group; and
an electronic receipt display unit configured to display the electronic receipt information transmitted by the electronic receipt transmission unit to the information processing device.

2. The system according to claim 1, wherein the electronic receipt display unit is configured to display the electronic receipt information according to company codes.

3. The system according to claim 1, further comprising:
a setting unit configured to set the electronic receipt information that is to be shared by the consumers who are in the group.

4. The system according to claim 3, further comprising:
a privacy setting unit configured to set the electronic receipt information to be private, even when the electronic receipt information has been set to be shared by the setting unit.

5. The system according to claim 4, wherein the privacy setting unit is configured to generate a conceal screen that displays a selectable item for designating a class of information as private.

6. The system according to claim 5, wherein the class includes an individual electronic receipt.

7. The system according to claim 5, wherein the class includes electronic receipt information generated from purchases at a particular store.

8. The system according to claim 4, wherein the privacy setting unit is configured to prevent electronic receipt information from being shared with one or more of the consumers who are in the group.

9. An information processing device, comprising:
a group associating unit configured to associate a code of a consumer with a group having codes of other consumers associated therewith;
an electronic receipt reception unit configured to receive electronic receipt information which is correlated with the code, and the electronic receipt information of one of the other consumers who are in the group, from an electronic receipt management server which manages the electronic receipt information; and
an electronic receipt display unit configured to display the electronic receipt information received by the electronic receipt reception unit.

10. The device according to claim 9, wherein the electronic receipt display unit is configured to display the electronic receipt information according to company codes.

11. The device according to claim 10, wherein the electronic receipt display unit is configured to display the electronic receipt information of the consumer and the electronic receipt information of one of the other consumers in the group.

12. The device according to claim 9, further comprising:
a setting unit configured to set the electronic receipt information that is to be shared by the consumers who are in the group.

13. The device according to claim 12, further comprising:
a privacy setting unit configured to set the electronic receipt information to be private, even when the electronic receipt information has been set to be shared by the setting unit.

14. The device according to claim 13, wherein the privacy setting unit is configured to generate a conceal screen that displays a selectable item for designating a class of information as private.

15. The device according to claim 14, wherein the class includes an individual electronic receipt.

16. The device according to claim 14, wherein the class includes electronic receipt information generated from purchases at a particular store.

17. The device according to claim 13, wherein the privacy setting unit is configured to prevent electronic receipt information from being shared with one or more of the consumers who are in the group.

18. A non-transitory computer readable medium comprising a program for causing an information processing device to carry out a method, the method comprising the steps of:
associating a code of a consumer with a group having codes of other consumers associated therewith;
receiving electronic receipt information which is correlated with the code, and the electronic receipt information of one of the other consumers who are in the group, from an electronic receipt management server which manages the electronic receipt information; and
displaying the electronic receipt information of the consumer and the electronic receipt information of one of the other consumers in the group.

19. The non-transitory computer readable medium according to claim 18, wherein the method further comprises:
setting the electronic receipt information that is to be shared by the consumers who are in the group.

20. The non-transitory computer readable medium according to claim 19, wherein the method further comprises:
setting the electronic receipt information that has been set to be shared by the consumers who are in the group to be private.
